(19) United States
(12) Patent Application Publication
(10) Pub. No.: US 2017/0361930 A1
(43) Pub. Date: Dec. 21, 2017

(54) FLYING VEHICLE

(71) Applicants: Kihyoun CHOI, Gunsan-si (KR); Soyeon CHOI, Gunsan-si (KR)

(72) Inventors: Kihyoun CHOI, Gunsan-si (KR); Soyeon CHOI, Gunsan-si (KR)

(21) Appl. No.: 15/597,331

(22) Filed: May 17, 2017

(30) Foreign Application Priority Data
Jun. 15, 2016 (KR) 10-2016-0074666

(51) Int. Cl. B64C 39/06; B64D 27/24; B64C 27/08

(52) U.S. Cl. CPC B64C 39/064; B64C 27/08; B64D 27/24

(57) ABSTRACT

The present disclosure relates to a flying vehicle comprising an annular hollow outer body having an outer circumferential open portion and an inner circumferential open portion; a blade system disposed in the outer body and configured to allow air flow from the outer circumferential open portion to the inner circumferential open portion; a first magnetic system configured to enable the blade system to be kept to have a clearance with the annular hollow outer body and to be kept in a floated state using a first magnetic force; a second magnetic system configured to allow the blade system to rotate using a second magnetic force; and a steering system configured to allow air discharged from the inner circumferential open portion via the blade system to flow upwardly or downwardly.

### CROSS-REFERENCE TO RELATED APPLICATION

This application claims the benefit of Korean patent application No. 10-2016-0074666 filed on Jun. 15, 2016, the entire content of which is incorporated herein by reference for all purposes as if fully set forth herein.

### BACKGROUND

### Field of the Present Disclosure

The present disclosure relates to a flying vehicle. In particular, the present disclosure relates to a flying vehicle comprising an annular hollow outer body having an outer circumferential open portion and an inner circumferential open portion; a blade system disposed in the outer body and configured to allow air flow from the outer circumferential open portion to the inner circumferential open portion; a first magnetic system configured to enable the blade system to be kept to have a clearance with the annular hollow outer body and to be kept in a floated state using a first magnetic force; a second magnetic system configured to allow the blade system to rotate using a second magnetic force; a steering system configured to allow air discharged from the inner circumferential open portion via the blade system to flow upwardly or downwardly; and a cap assembly configured to define the position of the outer circumferential open portion, whereby the blades rotate at a high speed and vertical movement and direction change of the flying are facilitated.

### Discussion of Related Art

Land and maritime transport means are being developed and used in real life. However, the development and realization of the aerial transportation means are insufficient.

In recent years, small-scale flying vehicles for transportation and/or for taking pictures, such as drones have been researched, developed, and activated. However, there is no adequate means to replace conventional airplanes for human transport.

Conventional airplanes use fossil fuels such as aviation oil and thus cause environmental problems due to air pollution. Further, there is a problem that noise and vibration are accompanied by use of the engine. Therefore, there is a need for environmentally friendly flight means with low noise.

A variety of the flying vehicles have been studied for this purpose. An example of such a prior art air vehicle is disclosed in Korean Patent Laid-Open Publication No. 10-2012-006693.

In Korean Patent Laid-Open Publication No. 10-2012-006693, a flying device is provided to reduce costs and to reduce environmental contamination by not using natural fuel, and to take off the flying device by sucking the external air and discharging the sucked air to a vertical discharge port. To this end, the flying device comprises a body part and a main fan. The body part comprises a lower body, an upper body, and lightening parts. A vertical discharge port is arranged in the lower body and downwardly discharges air sucked from the outside to the inside. The upper body is located on the top of the lower body. The lightening parts are respectively arranged in the upper body and the lower body, and selectively apply repulsive force to lighten the weight of the upper body and the lower body. The main fan is arranged in the lower body of the body part, and sucks the external air into the body part to generate buoyancy to the body part.

However, in the above-described prior art, air is sucked from below the lower body by the main fan and then discharged back toward below the lower body, so that it is difficult to achieve actual flight. Further, since the rotation of the blades is accomplished by a power source converted by a solar module, it is difficult to operate at night without the sun shining. Further, since the rotation of the blades for flight is realized by the driving of the motor, there is a problem in that the load on the rotation shaft is large and the durability thereof is degraded.

### PRIOR ART DOCUMENTS

[Patent Literature] Korean Patent Laid-Open Publication No. 10-2012-006693 publicized on Jun. 25, 2012.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a flying vehicle comprising an annular hollow outer body having an outer circumferential open portion and an inner circumferential open portion; a blade system disposed in the outer body and configured to allow air flow from the outer circumferential open portion to the inner circumferential open portion; a first magnetic system configured to enable the blade system to be kept to have a clearance with the annular hollow outer body and to be kept in a floated state using a first magnetic force; a second magnetic system configured to allow the blade system to rotate using a second magnetic force; a steering system configured to allow air discharged from the inner circumferential open portion via the blade system to flow upwardly or downwardly; and a cap assembly configured to define the position of the outer circumferential open portion, whereby the blades rotate at a high speed and vertical movement and direction change of the flying are facilitated.

In one aspect of the present disclosure, there is provided a flying vehicle comprising: an annular hollow outer body having an outer circumferential open portion defined in an outer circumference thereof and an inner circumferential open portion defined in an inner circumference thereof, wherein the outer open portion air-communicates with the inner open potion; a blade system comprising at least one blade, the blade system being rotatably disposed within the annular hollow outer body, wherein the blade system is configured to allow air flow from the outer circumferential open portion to the inner circumferential open portion; a first magnetic system including magnets arranged on the annular hollow outer body and the blade system respectively, wherein the first magnetic system is configured to enable the blade system to be kept to have a clearance with the annular hollow outer body and to be kept in a floated state using a first magnetic force; a second magnetic system including electromagnets placed on the annular hollow outer body and permanent magnets placed on the blade system, wherein the second magnetic system is configured to allow the blade system to rotate using a second magnetic force; a central inner body surrounded by the inner circumference of the annular hollow outer body; a steering system disposed along an outer circumference of the central inner body, wherein the steering system is configured to allow air discharged from the inner circumferential open portion via the blade system to flow upwardly or downwardly; a controller disposed within the central inner body, wherein the controller is configured to control rotation of the blade system and operation of the steering system; and a power supply disposed within the central inner body, wherein the power supply is configured to supply power to the controller and the electromagnets.

In one implementation, the annular hollow outer body has an air-communication space defined between the outer circumferential opening and the inner circumferential opening, wherein the blade system is kept to have the clearance with an inner face of the annular hollow outer body.

In one implementation, the first magnetic system includes: a plurality of first and second body-side permanent magnets arranged on an upper inner face and the lower inner face of the annular hollow outer body along the annular hollow outer body, wherein the first and second body-side permanent magnets have opposite polarities; and a plurality of first and second blade-side permanent magnets arranged on the blade system, wherein the first and second blade-side permanent magnets have opposite polarities, wherein the plurality of the first blade-side permanent magnets face away and correspond to the plurality of the first body-side permanent magnets respectively, wherein the plurality of the second blade-side permanent magnets face away and correspond to the plurality of the second body-side permanent magnets respectively, wherein the plurality of the first blade-side permanent magnets have the same polarity as the plurality of the first body-side permanent magnets respectively, wherein the plurality of the second blade-side permanent magnets have the same polarity as the plurality of the second body-side permanent magnets respectively, wherein the second magnetic system includes: a plurality of armature electromagnets arranged on the upper or lower inner face of the annular hollow outer body along the annular hollow outer body; and a plurality of field permanent magnets arranged on the blade system, wherein the plurality of armature electromagnets face away and correspond to the plurality of field permanent magnets respectively.

In one implementation, the blade system includes: at least two blades; an outer ring connecting outer ends of the blades; and an inner ring connecting inner ends of the blades, wherein the plurality of the first and second blade-side permanent magnets are arranged on the outer ring and the inner ring along the outer ring and the inner ring.

In one implementation, the blade system includes: an upper blade sub-system configured to enable intake of the air; and a lower blade sub-system configured to enable discharge of the air.

In one implementation, the annular hollow outer body further include a cap assembly disposed on the outer circumference of the annular hollow outer body, wherein the cap assembly is configured to define a position of the outer circumferential open portion along the outer circumference of the annular hollow outer body, wherein the cap assembly is controlled by the controller to define the position of the outer circumferential open portion along the outer circumference of the annular hollow outer body.

In one implementation, the cap assembly includes: a cap rail extending along the outer circumference of the annular hollow outer body; a cap configured to move along the cap rail; and a cap actuator configured to drive the cap.

In one implementation, the steering system includes: a plurality of steering plates arranged along an outer circumference of the central inner body, wherein each plate is configured to pivot up or down; hinge members pivotally coupled to the steering plates respectively; and a plurality of actuators, each actuator having one end operatively coupled to the each steering plate and the other end coupled to the central inner body.

In one implementation, the central inner body includes: an outer body adjacent to the steering system; an inner body received in the outer body, wherein the inner body is spaced from the outer body; and rotatable bearings disposed between the outer body and the inner body to allow relative displacement between the outer body and the inner body.

In one implementation, each of the electromagnets includes a superconductor, and the vehicle further comprises cooling means disposed nearby the electromagnets to cool the superconductor.

In one implementation, the vehicle further comprises a plurality of auxiliary propulsion means arranged in the annular hollow outer body along the annular hollow outer body, wherein each auxiliary propulsion means is configured to intake air from the outer circumferential open portion or the inner circumferential open portion and to discharge the air out of the inner circumferential open portion or the outer circumferential open portion respectively.

In one implementation, each auxiliary propulsion means includes: a drive motor configured to rotate bi-directionally; a drive shaft coupled to the motor; and at least one rotation blade coupled to the drive shaft, wherein the drive shaft is oriented in a radial direction with respect to the central inner body.

In accordance with the present disclosure, by using the magnets for rotation of the blades, there is no need for a motor directly driving the blades, and therefore a rotating shaft. Thus, the flying vehicle is lightweight, generates little noise and little vibration and has little abrasion, and has excellent durability.

According to the present disclosure, there is an advantage that the flying vehicle can be easily raised, lowered and changed in direction.

According to the present disclosure, there is an advantage that the flying vehicle can be operated environmentally.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a perspective view of a flying vehicle according to an embodiment of the present disclosure.

FIG. 2 is a control block diagram for a flying vehicle according to an embodiment of the present disclosure.

FIG. 3 is a perspective view of a flying vehicle in a state where a part of a hollow outer body of a flying vehicle according to an embodiment of the present disclosure is opened.

FIG. 4 is a top view of a flying vehicle according to an embodiment of the present disclosure.

FIG. 5 is a side elevation view of a flying vehicle according to an embodiment of the present disclosure.

FIG. 6 is a cross-sectional view of a flying vehicle according to an embodiment of the present disclosure.

FIG. 7 is a schematic view illustrating inflow and outflow of air into and out of a flying vehicle according to an embodiment of the present disclosure.

FIG. 8 is a schematic diagram illustrating movement of a flying vehicle according to an embodiment of the present disclosure.

FIG. 9 is a schematic view illustrating an orientation change around a central body of a flying vehicle according to an embodiment of the present disclosure.

FIG. 10 is a top view of a flying vehicle according to another embodiment of the present disclosure.

FIG. 11 is a cross-sectional view of a flying vehicle according to another embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

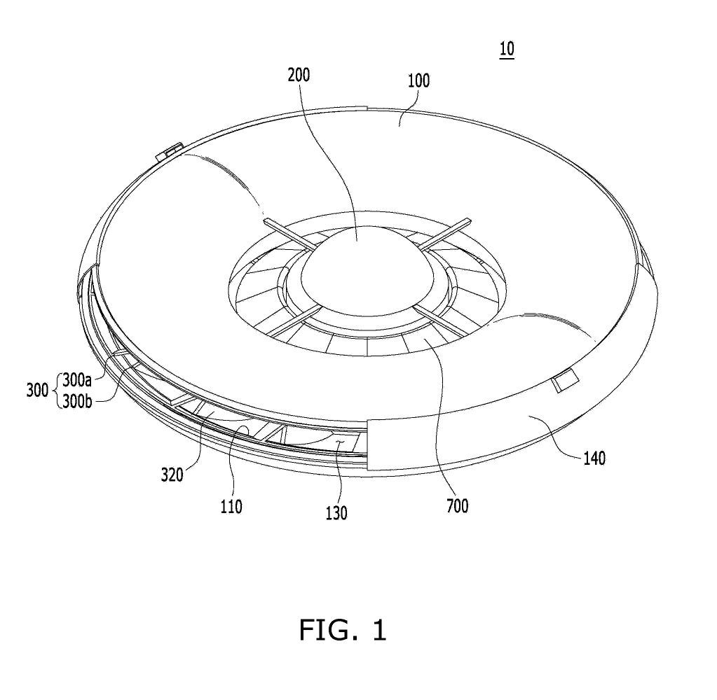

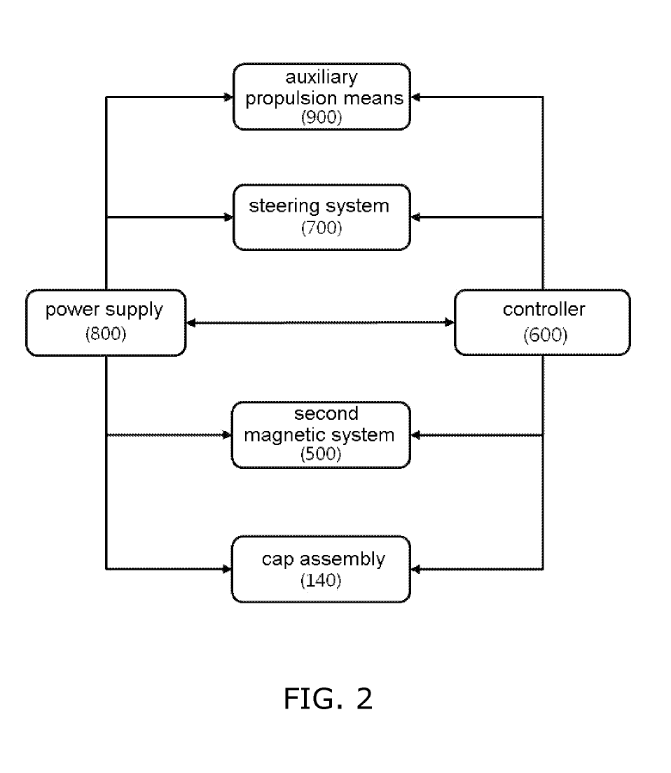

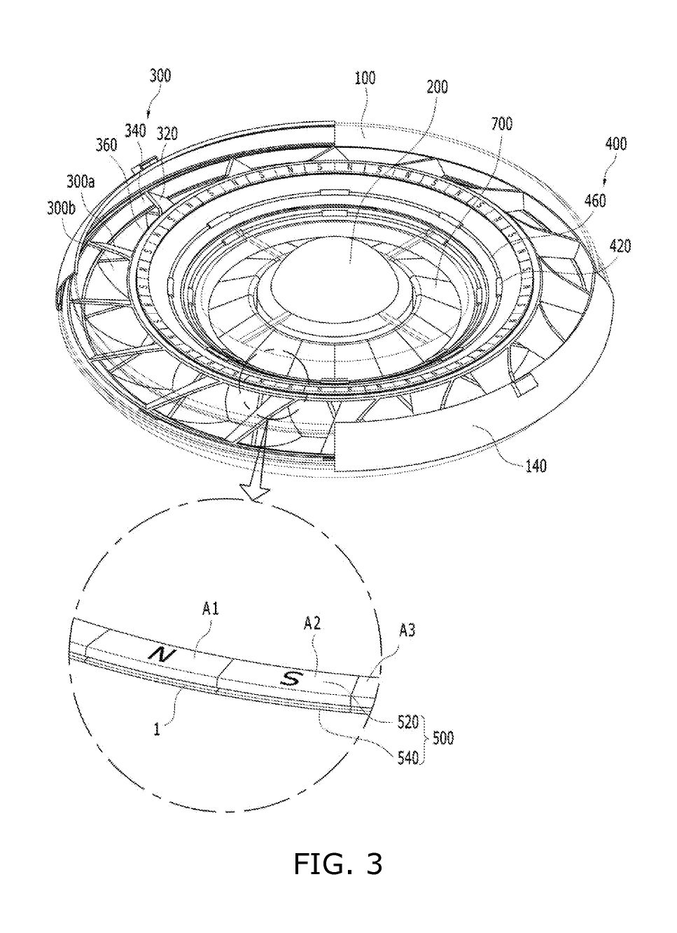

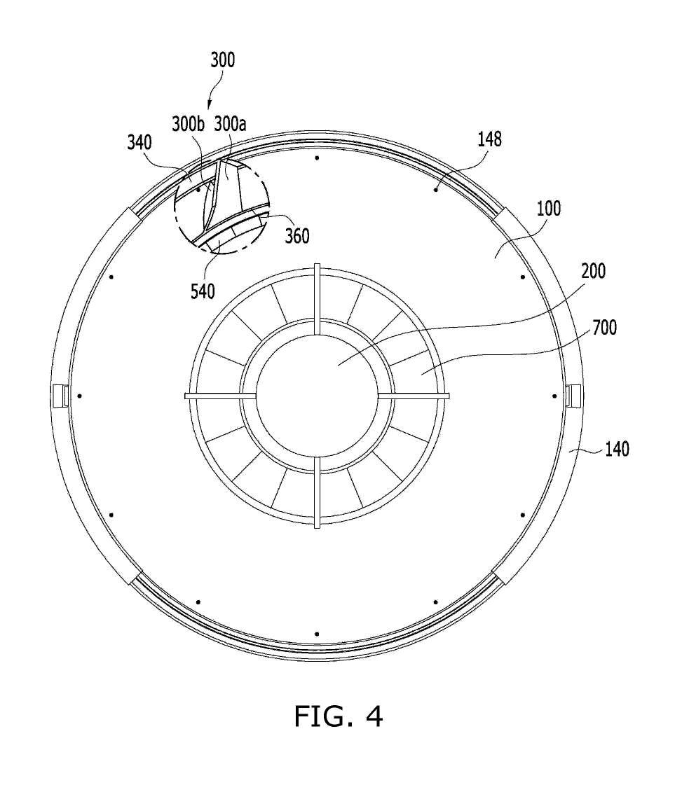

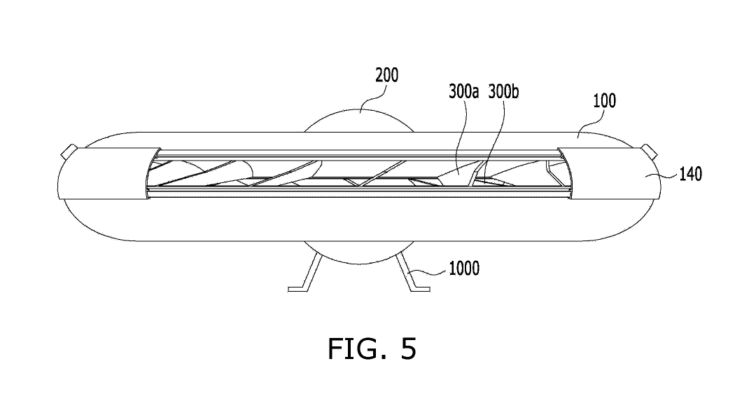

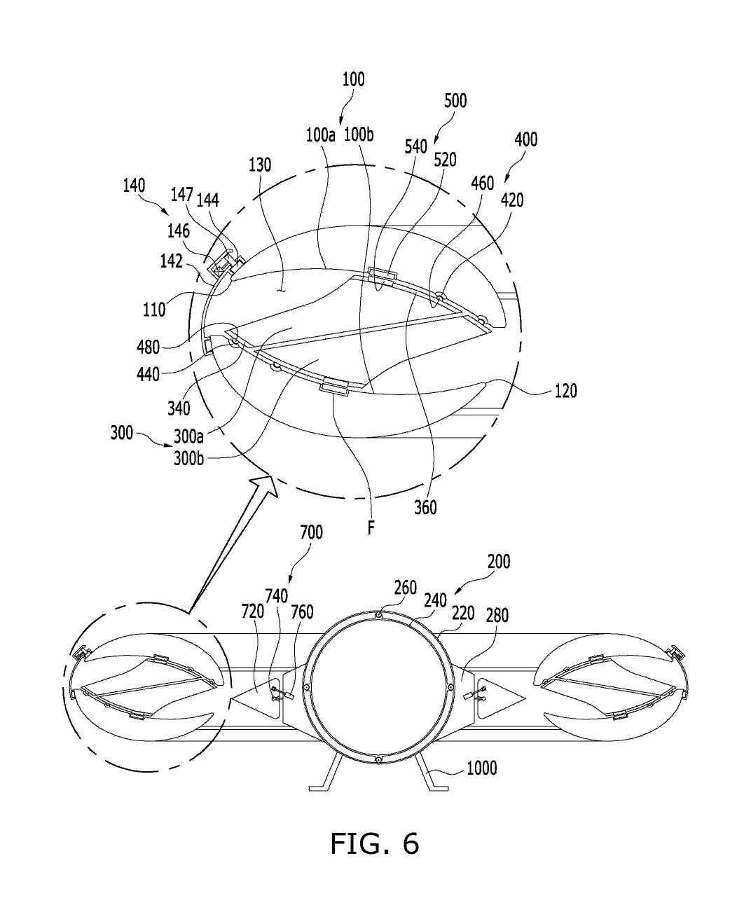

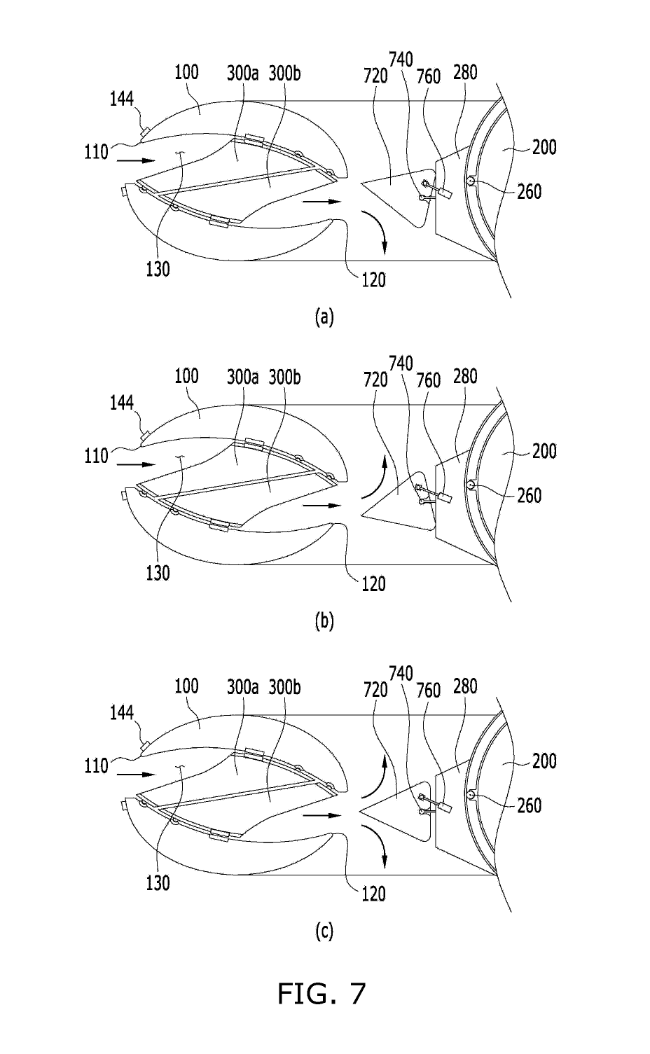

FIG. 1 is a perspective view of a flying vehicle according to an embodiment of the present disclosure. FIG. 2 is a control block diagram for a flying vehicle according to an embodiment of the present disclosure. FIG. 3 is a perspective view of a flying vehicle in a state where a part of a hollow outer body of a flying vehicle according to an embodiment of the present disclosure is opened. FIG. 4 is a top view of a flying vehicle according to an embodiment of the present disclosure. FIG. 5 is a side elevation view of a flying vehicle according to an embodiment of the present disclosure. FIG. 6 is a cross-sectional view of a flying vehicle according to an embodiment of the present disclosure. FIG. 7 is a schematic view illustrating inflow and outflow of air into and out of a flying vehicle according to an embodiment of the present disclosure.

The flying vehicle 10 according to an embodiment of the present disclosure is configured such that blades 320 are installed and is rotated using magnets. As shown in FIG. 1 and FIG. 3, the flying vehicle 10 includes an annular hollow outer body 100, first and second magnetic systems 400 and 500, a blade system 300, a steering system 700, and a central body 200.

The relative sizes of the annular hollow outer body 100, the central body 200, the blade system 300, and the steering system 700 in the drawings according to the embodiments of the present disclosure may be determined based on whether the flying vehicle 10 is unmanned or not, the number and weight of boarding persons, etc.

A portion of the outer circumference and a portion of the inner circumference of the annular hollow outer body 100 are opened and are air-communicated with each other.

Since the open portion of the outer circumference and the open portion of the inner circumference of the annular hollow outer body 100 are opened and air-communicated with each other, air may be introduced or discharged from or into the open portion of the outer circumference into or from the open portion of the inner circumference. The direction of the exhausted air may controlled by the steering system 700 so that the flying vehicle 10 according to an embodiment of the present disclosure can take off.

The annular hollow outer body 100 according to an embodiment of the present disclosure includes an outer circumferential opening 110 defined along the open portion of the outer circumference, an inner circumferential opening 120 defined along the open portion of the inner circumference, and an air-communication space 130 air-connecting the outer circumferential opening 110 and the inner circumferential opening 120.

In the outer circumferential opening 110, air is intaked, while in the inner circumferential opening 120, air is discharged. The blade system 300 includes at least one blade 320 and is rotatably installed within the annular hollow outer body 100.

The blade system 300 is configured to rotate such that air moves from the open portion of the outer circumference of the annular hollow outer body 100 to the open portion of the inner circumference.

The blades 320 may, in one embodiment, be implemented with the blades provided in a known axial flow fan.

The blades 320 is configured to move air by rotation thereof. Specifically, air is moved from a front or rear of the blade 320 to a rear or front of the blade 320.

In one embodiment, as shown in FIG. 6, the outer circumferential opening 110 is formed at a relatively higher position relative to the air-communication space 130, while the air-communication space 130 is formed at a relatively higher position relative to the inner circumferential opening 120.

In this connection, the air located outside the open portion of the outer circumference of the annular hollow outer body 100 is intaked into the open portion of the outer circumference of the annular hollow outer body 100 (that is, the outer circumferential opening 110) by the blade system 300 installed in the air-communication space 130. This air is moved to the open portion of the inner circumference (i.e., the inner circumferential opening 120) of the annular hollow outer body 100 by the blade system 300. Such air flow may be understood as the movement of air by a known axial flow fan.

That is, the outer circumferential opening 110 is formed at a position higher than the inner circumferential opening 120. Therefore, the air to be intaked from the outer circumferential opening 110 may be seen to be located behind the blade system 300. By rotation of the blades 320, the air moves toward a front of the blades and moves toward and is discharged from the inner circumferential opening 120. This results in natural airflow and discharge.

The blade system 300 according to an embodiment of the present disclosure is configured to maintain a gap with an inner face of the annular hollow outer body 100 within the air-communication space 130. The blade system 300 may be in a floating state.

In one embodiment, the gap between the blade system 300 and the inner surface of the annular hollow outer body 100, and the flotation state are achieved by the first magnetic system 400.

The first magnetic system 400 includes the magnets provided on the annular hollow outer body 100 and the blade system 300 respectively. The first magnetic system 400 may allow the blade system 300 to remain in a floating state while maintaining a gap with the annular hollow outer body 100 by a magnetic force.

The first magnetic system 400 includes first and second body-side permanent magnets 420 and 440 arranged along the circumference of the annular hollow outer body 100 on the upper and lower inner faces 100a and 100b of the annular hollow outer body 100 respective around the air-communication space 130.

The first magnetic system 400 further includes first and second blade-side permanent magnets 460 and 480 which are arranged on the blade system 300 in a corresponding manner with the first and second body-side permanent magnets 420 and 440 respectively. The first and second blade-side permanent magnets 460 and 480 may have the same polarities as those of the first and second body-side permanent magnets 420 and 440 respectively.

The first body-side permanent magnets 420 disposed on the upper inner face 100a of the annular hollow outer body 100 and the first blade-side permanent magnets 460 have the same polarities respectively and are arranged to correspond to each other. As a result, a repulsive force is generated between the first body-side permanent magnets 420 and the first blade-side permanent magnets 460 respectively.

Further, the second body-side permanent magnets 440 disposed on the lower inner face 100b of the annular hollow outer body 100 and the second blade-side permanent magnets 480 have the same polarities and are arranged to correspond to each other. Thus, a repulsive force is generated between the second body-side permanent magnets 440 and the second blade-side permanent magnets 480.

Therefore, a repulsive force is generated downwards from the upper inner face 100a of the annular hollow outer body 100 by the first magnetic system 400, and, a repulsive force is generated upwards from the lower inner face 100b of the annular hollow outer body 100 by the first magnetic system 400.

A gravity due to the weight of the blade system is added to the repulsive force generated downwards from the upper inner face 100a of the annular hollow outer body 100 by the first magnetic system 400 may be equal to the repulsive force generated upwards from the lower inner face 100b of the annular hollow outer body 100 by the first magnetic system 400. In this way, the blade system 300 may be spaced from the annular hollow outer body 100 and may be in a floated state.

In this connection, when the repulsive forces have the horizontal force components, the repulsive forces may be oriented such that the horizontal balance of the blade system may be achieved.

Each of the permanent magnets may be, for example, a known permanent magnet. Further, the corresponding and facing away magnets may be arranged so as to have N polarity-N polarity, or S polarity-S polarity.

The blade system 300 according to an embodiment of the present disclosure includes at least two blades 320. The blade system 300 may further include an outer ring 340 connecting the outer edges of the blades 320 and an inner ring 360 connecting the inner edges of the blades 320.

The outer ring 340 and the inner ring 360 are integrated with the two or more blades 320. Accordingly, the outer ring 340 and the inner ring 360 rotate together with the two or more blades 320. The first and second blade-side permanent magnets 460 and 480 may be arranged along the outer circumferential surfaces of the outer ring 340 and the inner ring 360 respectively.

The blade system 300 according to an embodiment of the present disclosure may be divided into the upper blade sub-system 300a and the lower blade sub-system 300b to individually effect the inflow and outflow of air.

The upper blade sub-system 300a ma be located closer to the outer circumferential opening 110 of the annular hollow outer body 100 that allows an air inflow. The lower blade sub-system 300b may be located closer to the inner circumferential opening 120 of the annular hollow outer body 100 that allows an air discharge. It is also possible to construct the opposite configuration.

Furthermore, the blade system 300 may be constructed such that the inflow and outflow of air by the rotation of the blade system 300 is faster and stronger. For this purpose, the blade system 300 may be constructed such that the upper blade sub-system 300a and the lower blade sub-system 300b may be rotate in the same direction (e.g., all clockwise) or in opposite directions (e.g., the upper blade sub-system 300a rotates clockwise while the lower blade sub-system 300b rotates counterclockwise).

Each of the blades 320 belonging to the upper blade sub-system 300a and the lower blade sub-system 300b may be inclined at different angles with respect to the rotation plane. The tilted angle may be selected particularly to achieve a structure in which the discharge of air is rapid.

The upper blade sub-system 300a may include an upper outer ring 340 that annularly connects the outer edges of each of the blades 320 and an upper inner ring 360 that connects the inner edges of each blades 320 annularly. Further, the lower blade sub-system 300b may include a lower outer ring 340 that annularly connects the outer edges of each blades 320 and a lower inner ring 360 that connects the inner edges of each blades 320 annularly.

In the flying vehicle 10 according to an embodiment of the present disclosure, the rotation of the blade system 300 is performed by the second magnetic system 500. The second magnetic system 500 causes the blade system 300 to be rotated by magnetic force.

To this end, the second magnetic system 500 includes armature electromagnets 520 provided on the annular hollow outer body 100 and field magnets provided on the blade system 300. Due to the change in polarities of the electromagnets 520, the blade system 300 is rotated.

In one embodiment, the second magnetic system 500 includes armature electromagnets 520 disposed on the upper or lower inner faces 100a and 100b of the annular hollow outer body 100 along the periphery of the body 100. The system 500 also includes field permanent magnets 540 disposed on the blade system 300 in a manner corresponding to the electromagnets 520 respectively.

In one embodiment, the second magnetic system 500 may be implemented in a similar manner to a known linear motor.

In one embodiment, the second magnetic system 500 may have a configuration similar to a linear synchronous motor (LSM). In this case, the armature electromagnets 520 disposed on the upper or lower inner face 100a or 100b of the annular hollow outer body 100 may be embodied as stator coils. The field permanent magnets 540 disposed on the blade system 300 may be implemented as a rotor.

For example, as shown in FIG. 3, when a region (hereinafter referred to as 1 region) of the field permanent magnets 540 and a region (hereinafter referred to as A1 region) of the armature electromagnets 520 corresponding to the 1 region have the same polarity, a mutual repulsive force may be generated between the field permanent magnets 540 and the armature electromagnets 520 respectively.

When the second magnetic system 500 is controlled such that a region (hereinafter referred to as an A2 region) adjacent to the A1 region of the armature electromagnets 520 has a polarity different from the 1 region of the field permanent magnets 540, a mutual attractive force is generated between the A2 region and the 1 region of the field permanent magnets 540.

In this connection, the attraction force to attract the field permanent magnets 540 by the A2 region of the armature electromagnets 520 and the repulsion force to push away the field permanent magnets 540 by the A1 region of the armature electromagnets 520 together push the 1 region of the field permanent magnets 540 to face and correspond to the A2 region of the armature electromagnet 520.

Thereafter, when the second magnetic system 500 is controlled such that the polarity of the A2 region of the armature electromagnets 520 has the same polarity as the 1 region of the field permanent magnets 540, and the polarity of a region (hereinafter, A3 region) adjacent to the A2 region of the armature electromagnets 520 is opposite to the polarity of the 1 region of the field permanent magnets 540, the 1 region of the field permanent magnets 540 is moved to face and correspond to the A3 region of the armature electromagnets 520. In this way, the field permanent magnets 540 are rotated.

Such arrangements of the armature electromagnets 520 and field permanent magnets 540 allows the strong propulsive forces. Thus, the blade system 300 according to an embodiment of the present disclosure can rotate at high speed.

In one embodiment, the field permanent magnets 540 may be implemented by the known annular magnets including N poles and S poles being sequentially arranged in an annular shape.

In one embodiment, the armature electromagnets 520 are arranged in an annular fashion in a corresponding manner to the field permanent magnets 540 respectively. The currents are alternately controlled so that the polarities of the magnetic portions corresponding to each other are changed to be the same or opposite over time. Alternating the positions of the N and S poles may be implemented as is well known in known electromagnets.

In one embodiment, the armature electromagnets 520 are preferably configured to exhibit strong magnetic forces. The armature electromagnets 520 may include a superconductor.

To construct electromagnets 520 with strong magnetism, a lot of coils or a lot of current must be supplied. However, when the superconductor is used, a strong magnetic force is generated even when a large number of coils are not wound. Therefore, the size and weight of the electromagnets are reduced, and no electrical resistance is generated. Therefore, the current is not converted into heat in the coil, and strong magnetic force is generated even by using a small current.

However, as shown in FIG. 6, it is preferable that cooling means F for lowering the temperature of the superconductor electromagnets 520 is further provided nearby the electromagnets 520, because the superconductors have a reduced electrical resistance as the temperature is lower.

The cooling means F may be realized as cooling means using a known electric driving system, a mechanical system or a refrigerant system.

The central body 200 is surrounded by the inner circumference of the annular hollow outer body 100. The central body 200 may be connected to the annular hollow outer body 100 via connectors 160.

In one embodiment, when the flying vehicle 10 is operated by a person, the central body 200 has an inner space enough for a pilot to ride in. The pilot controls the flying vehicle 10 within the central body 200.

The central body 200 includes a controller 600 for controlling the rotation of the blade system 300 and the operation of the steering system 700, and a power supply 800 for supplying power to the controller 600 and the electromagnets 520.

FIG. 2 is a control block diagram for a flying vehicle according to an embodiment of the present disclosure. This diagram shows a configuration in which control by the controller 600 included in the central body 200 and power supply by the power supply 100 are performed.

The controller 600 controls the current supplied from the power supply 800 to the armature electromagnets 520 included in the second magnetic system 500, thereby causing the blade system 300 to rotate in a desired direction. The controller 600 also controls the steering system 700 to cause the flying vehicle 10 to ascend and descend. The controller 600 controls a cap assembly 140 and auxiliary propulsion means 900 to be described later, thereby causing the flying vehicle 10 to move in a specific direction.

The controller 600 may include an instrument panel and an operation panel for checking the control status. The controller 600 may further include a reception antenna for receiving a control signal transmitted from the outside of the flying vehicle 100 via wireless communication.

As shown in FIG. 2, the power supply 800 supplies power to the steering system 700, the cap assembly 140, and the auxiliary propulsion means 900, in addition to the armature electromagnets 520 included in the second magnetic system 500. In one embodiment, the power supply 800 may include a known battery.

The air discharged to the inner circumferential opening 120 by the blade system 300 is guided and discharged via the steering system 700 out of the vehicle.

The steering system 700 is disposed along the outer perimeter of the central body 200. The steering system 700 is actuated by the blade system 300 so that the exhausted air to the open portion of the inner circumference of the annular hollow outer body 100 is allowed to be discharged upwards or downwards out of the vehicle.

In one embodiment, the steering system 700 includes a plurality of steering members 720 disposed along the outer periphery of the central body 200 and pivoting up and down within a predetermined range, a plurality of hinge members 740 to allow the steering members 720 to pivot up or down, the plurality of hinge members 740 pivotally coupled to the plurality of hinge members 740 respectively, and actuators 760, one end of which is operatively coupled to each of the steering members 720 and the other end of which is operatively coupled to the central body 200.

In one embodiment, each of the actuators 760 may be implemented with a known hydraulic cylinder. In another embodiment, the actuator may comprise a known motor and a pinion gear.

The actuators 760 each may be configured to allow each of the steering members 720 to pivot about each of the hinge members 740.

In one embodiment, as shown in FIG. 7a, when each of the actuators 760 pulls each of the steering members 720 at an upper hinge, a distal end (i.e., the end closer to the blade system) of each of the steering members 720 is pivoted upwards.

When the distal end of each of the steering members 720 is pivoted upwards, the air input into the outer circumferential opening 110 and then transferred by the blade system 300 installed in the air-communication space 130 into the inner circumferential opening 120 is mainly discharged downwards from the flying vehicle 10. Thus, ascend of the flying vehicle 10 according to an embodiment of the present disclosure is achieved.

As shown in FIG. 7b, when each of the actuators 760 pulls each of the steering members 720 at a lower hinge, a distal end (i.e., the end closer to the blade system) of each of the steering members 720 is pivoted downwards. When the distal end of each of the steering members 720 is pivoted downwards, the air input into the outer circumferential opening 110 and then transferred by the blade system 300 installed in the air-communication space 130 into the inner circumferential opening 120 is mainly discharged upwards from the flying vehicle 10. Thus, descend of the flying vehicle 10 according to an embodiment of the present disclosure is achieved.

As shown in FIG. 7c, each of the steering members 720 has a proximal end coupled to the upper and lower hinges. The air input into the outer circumferential opening 110 and then transferred by the blade system 300 installed in the air-communication space 130 into the inner circumferential opening 120 is discharged upwards and downwards from the flying vehicle 1. Thus, when the downward air flow is greater than the upward air flow, the vehicle is ascended. When the upward air flow is greater than the downward air flow, the vehicle is descended.

In one embodiment, when the downward air flow is equal to the upward air flow, the vehicle is not descended or ascended but is kept in a floated state as it is. In this connection, each of the steering members 720 is not pulled at any of the upper and lower hinges.

As shown in FIG. 6, each of the steering members 720 is coupled to each attachment 280 attached to the central body 200 via the upper and lower hinges. The actuator is installed in the attachment 280. In an alternative, each of the steering members 720 is directly coupled to the central body 200 via the upper and lower hinges.

The attachment 280 may incorporate at least a portion of the controller 300 and/or the power supply.

The annular hollow outer body 100 according to an embodiment of the present disclosure further includes the cap assembly 140. The cap assembly 140 may be disposed in a remaining portion of the outer circumference of the body 100. The cap assembly 140 closes the remaining portion of the outer circumference.

In one embodiment, as shown in FIG. 6, the cap assembly 140 includes a cap rail 144 extending along the outer periphery of the annular hollow outer body 100, a cap 142 configured to move along the cap rail 144, and a cap actuator 146 for driving the cap 142.

The cap 142 has a larger area than the outer circumferential opening 110 so as to close at least a portion of the outer circumferential opening 110. The cap 42 blocks air from entering the outer circumferential opening 110 in a certain region of the annular hollow outer body 100.

The cap 142 is configured to be able to change its position along the cap rail 144. Therefore, the position at which the air inflow is blocked can be changed.

In one embodiment, the cap actuator 146 includes a bi-directionally rotatable drive motor, and a rail-contact portion 147 which is provided on the rotational axis of the drive motor and which is in pressure contact with the top of the cap rail 144.

The cap 142 moves clockwise or counterclockwise on the cap rail 144 via rotation of the rail-contact portion together with the rotation of the driving motor. Thus, in a predetermined region, closure of the outer circumferential opening 110 is achieved.

The cap assembly 140 according to an embodiment of the present disclosure may further include a cap sensor 148 as shown in FIG. 4. The sensor 148 may be configured to detect the position of the cap 142 and to identify the stop position of the cap 142 after being moved by the cap actuator 146. The driving of the cap assembly 140 is controlled by the controller 600 described above.

The cap sensor 148 may be embodied as, for example, an optical sensor, a touch sensor, or the like.

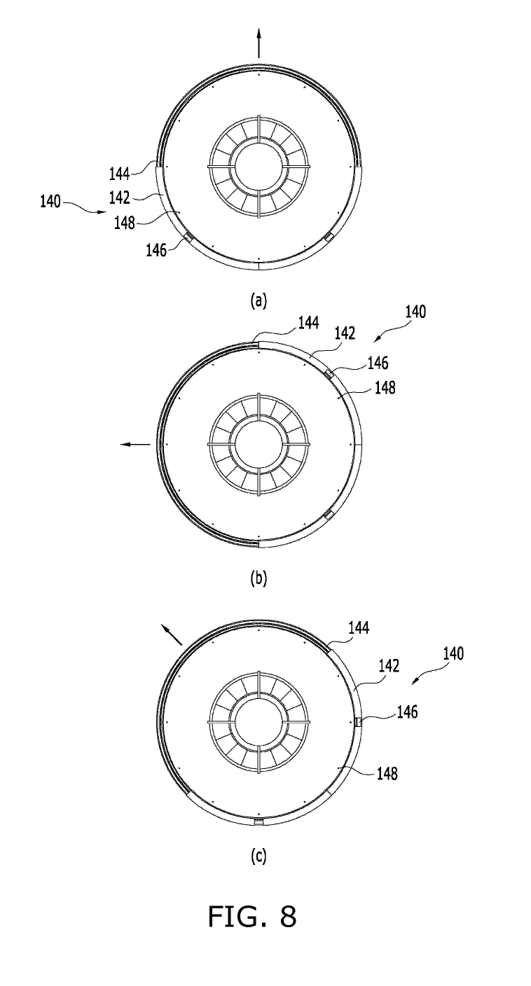

FIG. 8 is a schematic diagram illustrating movement of the flying vehicle according to an embodiment of the present disclosure.

As shown in FIG. 8, the cap assembly 140 may include two caps 142 each covering a quarter of the circumference of the outer body 100. Based on the traveling direction of the flying vehicle 10, the position of the cap 142 is controlled. Thus, the flying vehicle 10 can be advanced in a desired direction.

In one embodiment, as shown in FIG. 4, when the controller 600 controls the cap actuator 146 such that the two caps 142 are placed symmetrically along the outer circumference of the body 100, the blade system 300 rotates continuously and the inflow of air from the outer circumferential opening 110 at an area that is not closed by the cap assembly 140 is achieved symmetrically. Thereby, the flying vehicle 10 may be controlled not to move in any specific direction.

The flying vehicle 10 according to an embodiment of the present disclosure is preferably controlled so as not to move in any specific direction except for vertical movement for stable movement when taking off or landing on the ground. To this end, it is desirable to control the cap 142 to be symmetrically arranged so that air is allowed to flow symmetrically.

In another embodiment, as shown in FIGS. 8a-c, the controller 600 is configured to control the cap actuator 146 such that both of the two caps 142 are placed in a rear region of the body 100 in terms of the direction of travel of the vehicle. In this case, while the blade system 300 is continuously rotating, air is introduced into the outer circumferential opening 110 in a front region of the body 100 in terms of the traveling direction of the flying vehicle, and the outer circumferential opening 110 in the rear region of the body 100 in terms of the traveling direction of the flying vehicle is closed.

In this way, nearby the outer circumferential opening no in the front region of the body 100 in terms of the traveling direction of the flying vehicle, a propulsive force is generated by the negative pressure, whereby the flying vehicle 10 moves in the traveling direction.

The controller 600 may control the cap actuator 146 to move the position of the cap assembly 140 to the left side of the body when the flying vehicle 10 intends to move to the right side. The controller 600 may control the cap actuator 146 to move the position of the cap assembly 140 to the right side of the body when the flying vehicle 10 intends to proceed to the left.

The movement of the cap assembly 140 is controlled by the cap actuators 146 and the cap sensor 148, and power for driving the assembly 140 is supplied from the power supply 800 described above.

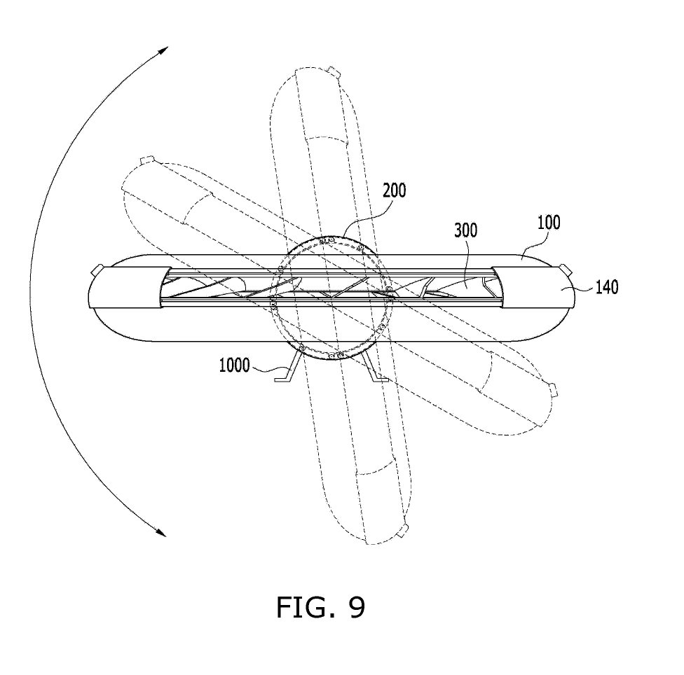

FIG. 9 is a schematic view illustrating an orientation change around a central body of a flying vehicle according to an embodiment of the present disclosure.

When the central body 200 according to an embodiment of the present disclosure is configured for a manned flying vehicle 10, as shown in FIG. 6, the central body 200 includes an outer body 220 coupled to the steering system 700, an inner body 240 formed inside the outer body 220, wherein the inner and outer bodies are spaced from each other, and rotatable bearings 260 to allow relative displacement between the outer body 220 and the inner body 240.

With the inner body 240 being fixed in the orientation, the rotatable bearings 260 enable free relative displacement of the remaining portions of the flying vehicle 10 except for the inner body 240. Within the inner body 240, the pilot controlling the flying vehicle 10 is able to steer the flying vehicle 10 at a stable posture while a seat for the pilot is parallel to the ground.

The rotatable bearings 260 enable free relative displacement of the remaining portions of the flying vehicle 10, even during braking or reversing of the flying vehicle 10. In this way, the impact on the flying vehicle 10 and/or the pilot due to the inertial may be reduced. Thus, stable steering of the flying vehicle 10 is made possible.

The rotatable bearings 260 may be embodied as rotatable bearings of various configurations to enable relative displacement between the outer body 220 and the inner body 240. For example, the rotatable bearings 260 may be implemented of a ball bearing type, a roller bearing type, or the like.

The central body 200 may include rotatable bearings 260 even when the flying vehicle 10 according to an embodiment of the present disclosure is configured as an unmanned flying vehicle 10. In order to remotely control the unmanned flying vehicle 10, an observation camera (not shown) for observing the inside and outside of the flying vehicle 10 may be further provided.

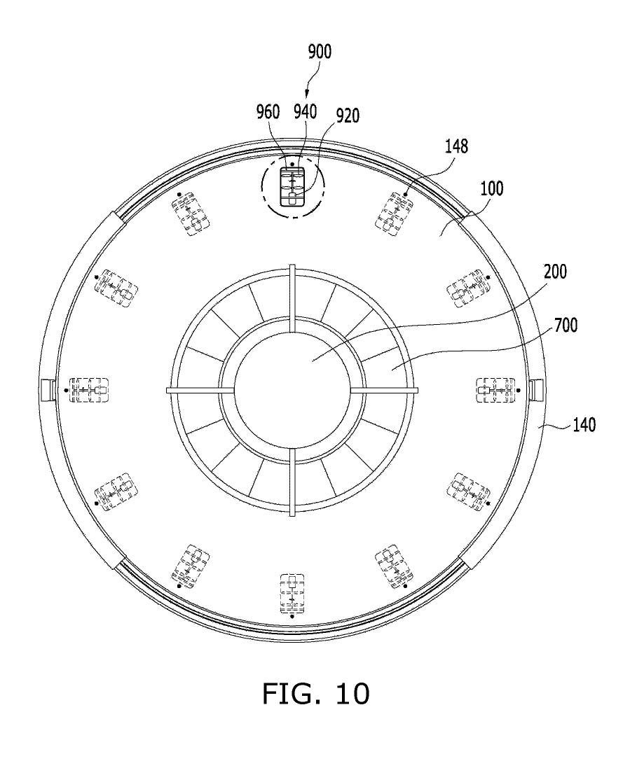

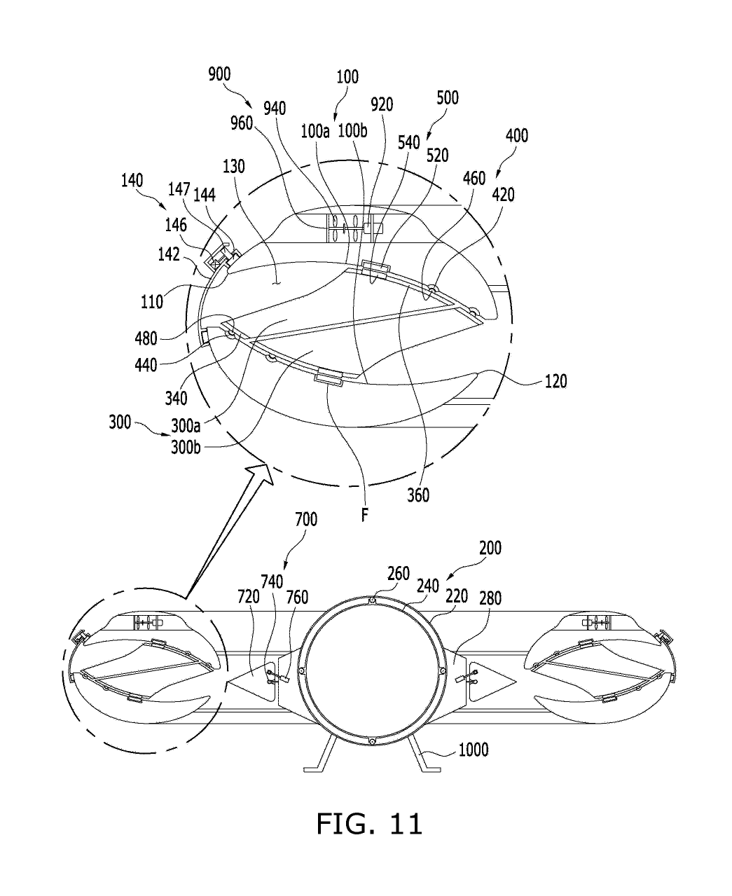

FIG. 10 is a plan view of a flying vehicle according to another embodiment of the present disclosure. FIG. 11 is a cross-sectional view of the flying vehicle according to another embodiment of the present disclosure.

The flying vehicle 10 according to another embodiment of the present disclosure further includes auxiliary propulsion means 900, as shown in FIG. 11. The auxiliary propulsion means 900 is located within the annular hollow outer body 100.

The auxiliary propulsion means 900 is configured to draw air from the open portion of the outer circumference or the open portion of the inner circumference and discharge the air out of the open portion of the inner circumference or the open portion of the outer circumference respectively.

The auxiliary propulsion means 900 assists the flying vehicle 10 according to an embodiment of the present disclosure to have a further driving force to move quickly. The auxiliary propulsion means 900 may be provided above and/or below the blade system 300. The auxiliary propulsion means 900 may be plural.

The number of the auxiliary propulsion means 900 may be determined based on the weight of the flying vehicle 10, propulsion force thereof, and the like. Preferably, the plurality of auxiliary propulsion means 900 are symmetrically arranged along the central body 200 for stable operation of the flying vehicle 10.

In one embodiment, the auxiliary propulsion means 900 includes at least one drive motor 920 capable of bidirectional rotation and at least one rotation blade 940 coupled to the rotation shaft from the drive motor 920.

In one embodiment, the auxiliary propulsion means 900 further includes a support frame 960. The drive motor 920 and rotation blades 940 are secured to the annular hollow outer body 100 via the support frame 960, as shown in FIG. 11.

The annular hollow outer body 100 may have auxiliary openings (reference numerals are not shown) in a portion of the outer circumference and a portion of the inner circumference thereof. Through the auxiliary openings, air is sucked and discharged by the auxiliary propulsion means 900.

In one embodiment, the drive motor 920 may be implemented as a known bidirectional rotary motor.

The drive motor 920 is powered by the power supply 800 and is controlled by the controller 600.

The drive motor 920 may rotate the rotation blades 940 clockwise or counterclockwise. In one embodiment, during the clockwise rotation thereof, air is drawn from the open portion of the outer circumference and exits out of the open portion of the inner circumference. In the counterclockwise rotation thereof, air is drawn from the open portion of the inner circumference and exits out of the open portion of the outer circumference.

In this way, the flow direction of the air can be changed in accordance with the rotation direction of the rotation blades. Therefore, regardless of whether the auxiliary propulsion means 900 according to an embodiment of the present disclosure is oriented toward the outer circumferential side or the inner circumferential side of the body 100, the direction of air movement can be controlled as desired.

In one embodiment, the rotation shafts from the drive motors 920 are arranged radially with respect to the central body 200, as shown in FIG. 10.

In the flying vehicle 10 according to another embodiment of the present disclosure, the annular hollow outer body 100 exists outside the central body 200, and the annular hollow outer body 100 is formed symmetrically with respect to the central body 200. Thus, it may be preferable that the rotation shafts from the drive motors 920 are arranged radially with respect to the central body 200, as shown in FIG. 10.

Since the rotation shafts from the drive motors 920 are arranged radially with respect to the central body 200, the air flow may be realized symmetrically with respect to a direction of the outer circumferential side or the inner circumferential side of the body 100. Thus, the positioning and movement of the flying vehicle 10 according to another embodiment of the present disclosure can be balanced.

In one embodiment, the auxiliary propulsion means 900 may include twelve drive motors 920 as shown in FIG. 10. However, the present disclosure is not limited thereto.

The auxiliary propulsion means 900 may be driven in addition to the rotation of the blade system 300 when the flying vehicle 10 according to another embodiment of the present disclosure is advanced in a specific direction.

In one embodiment, the auxiliary propulsion means 900 may be configured to drive the drive motors 920 at three locations in front of the direction of travel of the vehicle and to drive the drive motors 920 at three locations in rear of the direction of travel of the vehicle. The drive motors 920 at the three locations in front of the direction of travel of the vehicle are controlled such that air is drawn from the open portion of the outer circumference and is discharged out of the open portion of the inner circumference. At the same time, the drive motors 920 at the three locations in rear of the direction of travel of the vehicle are controlled such that air is drawn from the open portion of the inner circumference and is discharged out of the open portion of the outer circumference. This allows for further propulsion of the flying vehicle 10 in the direction that it wishes to proceed.

Another example of the auxiliary propulsion means 900 may include a jet engine. The jet engines are arranged radially with respect to the central body 200. Preferably, in order to prevent the flying vehicle 10 from being damaged due to heat, the jet engines may be oriented to inject the discharged gas in the outer circumferential direction.

In one embodiment, when the auxiliary propulsion means 900 includes twelve jet engines, the jet engines at three locations in rear of the direction of travel of the vehicle may be driven.

The flying vehicle 10 according to an embodiment of the present disclosure may further include a vehicle support 1000 extending downward from the central body 200 as shown in FIG. 5. The vehicle support 1000 supports the flying vehicle 10.

The vehicle support 1000 allows the flying vehicle 10 to land safely on the ground. The vehicle support 1000 allow a space between the ground and the flying vehicle 10 to minimize the impact on the ground when the vehicle vents air for the elevation of the flying vehicle 10.

It is to be understood that while the present disclosure has been particularly shown and described with reference to the exemplary embodiments thereof, the disclosure is not limited to the disclosed exemplary embodiments. On the contrary, it will be understood by those skilled in the art that various modifications may be made without departing from the spirit and scope of the present disclosure.

It is understood by those skilled in the art that various variants and alternatives may be selected in the present disclosure without departing from the spirit or scope of the present disclosure. Accordingly, it is intended that the present disclosure covers the modifications and variations when they come within the scope of the appended claims and their equivalents.

Reference numerals

| | |
|---|---|
| 10: flying vehicle | 100: annular hollow outer body |
| 110: outer circumferential opening | 120: inner circumferential opening |
| 130: air-communication space | 140: cap assembly |
| 200: central body | 300: blade system |
| 300a: upper blade sub-system | 300b: lower blade sub-system |
| 320: blades | 340: outer ring |
| 360: inner ring | 400: first magnetic system |

420: first body-side permanent magnets
440: second body-side permanent magnets
460: first blade-side permanent magnets
480: second blade-side permanent magnets

| | |
|---|---|
| 500: second magnetic system | 520: armature electromagnets |
| 540: field permanent magnets | 600: controller |
| 700: steering system | 720: steering members |
| 740: hinge members | 760: actuator |
| 800: power supply | 900: auxiliary propulsion means |
| 1000: vehicle support | F: cooling means |

What is claimed is:

1. A flying vehicle comprising:
an annular hollow outer body having an outer circumferential open portion defined in an outer circumference thereof and an inner circumferential open portion defined in an inner circumference thereof, wherein the outer open portion air-communicates with the inner open potion;
a blade system comprising at least one blade, the blade system being rotatably disposed within the annular hollow outer body, wherein the blade system is configured to allow air flow from the outer circumferential open portion to the inner circumferential open portion;
a first magnetic system including magnets arranged on the annular hollow outer body and the blade system respectively, wherein the first magnetic system is configured to enable the blade system to be kept to have a clearance with the annular hollow outer body and to be kept in a floated state using a first magnetic force;
a second magnetic system including electromagnets placed on the annular hollow outer body and permanent magnets placed on the blade system, wherein the second magnetic system is configured to allow the blade system to rotate using a second magnetic force;
a central inner body surrounded by the inner circumference of the annular hollow outer body;
a steering system disposed along an outer circumference of the central inner body, wherein the steering system is configured to allow air discharged from the inner circumferential open portion via the blade system to flow upwardly or downwardly;
a controller disposed within the central inner body, wherein the controller is configured to control rotation of the blade system and operation of the steering system; and
a power supply disposed within the central inner body, wherein the power supply is configured to supply power to the controller and the electromagnets.

2. The vehicle of claim 1, wherein the annular hollow outer body has an air-communication space defined between the outer circumferential opening and the inner circumferential opening, wherein the blade system is kept to have the clearance with an inner face of the annular hollow outer body.

3. The vehicle of claim 2, wherein the first magnetic system includes:
a plurality of first and second body-side permanent magnets arranged on an upper inner face and the lower inner face of the annular hollow outer body along the annular hollow outer body, wherein the first and second body-side permanent magnets have opposite polarities; and
a plurality of first and second blade-side permanent magnets arranged on the blade system, wherein the first and second blade-side permanent magnets have opposite polarities,
wherein the plurality of the first blade-side permanent magnets face away and correspond to the plurality of the first body-side permanent magnets respectively,
wherein the plurality of the second blade-side permanent magnets face away and correspond to the plurality of the second body-side permanent magnets respectively,
wherein the plurality of the first blade-side permanent magnets have the same polarity as the plurality of the first body-side permanent magnets respectively,
wherein the plurality of the second blade-side permanent magnets have the same polarity as the plurality of the second body-side permanent magnets respectively,
wherein the second magnetic system includes:
a plurality of armature electromagnets arranged on the upper or lower inner face of the annular hollow outer body along the annular hollow outer body; and
a plurality of field permanent magnets arranged on the blade system,
wherein the plurality of armature electromagnets face away and correspond to the plurality of field permanent magnets respectively.

4. The vehicle of claim 3, wherein the blade system includes:
at least two blades;
an outer ring connecting outer ends of the blades; and
an inner ring connecting inner ends of the blades,
wherein the plurality of the first and second blade-side permanent magnets are arranged on the outer ring and the inner ring along the outer ring and the inner ring.

5. The vehicle of claim 1, wherein the blade system includes:
an upper blade sub-system configured to enable intake of the air; and
a lower blade sub-system configured to enable discharge of the air.

6. The vehicle of claim 1, wherein the annular hollow outer body further include a cap assembly disposed on the outer circumference of the annular hollow outer body, wherein the cap assembly is configured to define a position of the outer circumferential open portion along the outer circumference of the annular hollow outer body,
wherein the cap assembly is controlled by the controller to define the position of the outer circumferential open portion along the outer circumference of the annular hollow outer body.

7. The vehicle of claim 6, wherein the cap assembly includes:
a cap rail extending along the outer circumference of the annular hollow outer body;
a cap configured to move along the cap rail; and
a cap actuator configured to drive the cap.

8. The vehicle of claim 1, wherein the steering system includes:
a plurality of steering plates arranged along an outer circumference of the central inner body, wherein each plate is configured to pivot up or down;
hinge members pivotally coupled to the steering plates respectively; and
a plurality of actuators, each actuator having one end operatively coupled to the each steering plate and the other end coupled to the central inner body.

9. The vehicle of claim 1, wherein the central inner body includes:
an outer body adjacent to the steering system;
an inner body received in the outer body, wherein the inner body is spaced from the outer body; and
rotatable bearings disposed between the outer body and the inner body to allow relative displacement between the outer body and the inner body.

10. The vehicle of claim 1, wherein each of the electromagnets includes a superconductor, and the vehicle further comprises cooling means disposed nearby the electromagnets to cool the superconductor.

11. The vehicle of claim 1, further comprising a plurality of auxiliary propulsion means arranged in the annular hollow outer body along the annular hollow outer body, wherein each auxiliary propulsion means is configured to intake air from the outer circumferential open portion or the inner circumferential open portion and to discharge the air out of the inner circumferential open portion or the outer circumferential open portion respectively.

12. The vehicle of claim 11, wherein each auxiliary propulsion means includes:
a drive motor configured to rotate bi-directionally;
a drive shaft coupled to the motor; and
at least one rotation blade coupled to the drive shaft,
wherein the drive shaft is oriented in a radial direction with respect to the central inner body.
